(19) United States
(12) Patent Application Publication
(10) Pub. No.: US 2012/0009399 A1
(43) Pub. Date: Jan. 12, 2012

(54) Double-sided pressure-sensitive adhesive sheet for fixing flexible printed circuit board and method for manufacturing the same

(75) Inventors: Takahiro Nonaka, Osaka (JP); Noritsugu Daigaku, Osaka (JP); Rie Kuwahara, Osaka (JP)

(73) Assignee: NITTO DENKO CORPORATION, Ibaraki-shi (JP)

(21) Appl. No.: 13/067,925

(22) Filed: Jul. 7, 2011

(30) Foreign Application Priority Data
Jul. 12, 2010 (JP) 2010-157902

(51) Int. Cl. C09J 7/02; B32B 33/00; B32B 27/08; B32B 7/10; B32B 37/12; B32B 37/14

(52) U.S. Cl. 428/214; 156/60; 428/220

(57) ABSTRACT

Disclosed is a double-sided pressure-sensitive adhesive sheet for fixing a flexible printed circuit board, which has silicone release liners, but is less polluting and excels in workability. The double-sided pressure-sensitive adhesive sheet for fixing a flexible printed circuit board includes at least a pressure-sensitive adhesive unit including a substrate and pressure-sensitive adhesive layers present on or above both sides of the substrate; and silicone release liners present on or above both surfaces of the pressure-sensitive adhesive unit, in which the pressure-sensitive adhesive layers each include an acrylic polymer based on, as an essential monomer component, an alkyl (meth)acrylate whose alkyl moiety being a linear or branched-chain alkyl group having 1 to 14 carbon atoms, the pressure-sensitive adhesive unit has a thickness of 60 μm or less, and the adhesive sheet evolves siloxane gas, if any, in an amount of 1 ng/cm² or less when heated at 120° C. for 10 minutes.

### TECHNICAL FIELD

The present invention relates to a double-sided pressure-sensitive adhesive sheet used for fixing or securing a flexible printed circuit board; and to a method for manufacturing the double-sided pressure-sensitive adhesive sheet.

### BACKGROUND ART

Double-sided pressure-sensitive adhesive sheets (double-sided self-adhesive sheets) are currently generally used for fixing a flexible printed circuit board (hereinafter also referred to as “FPC”) typically to a cabinet in the fabrication of hard disk drives (magnetic recording systems; HDDs).

Among them, double-sided pressure-sensitive adhesive sheets each having silicone release liners suffer from such problems that silicone compounds present in the silicone release liners contaminate the adherends, or the silicone compounds evolve siloxane gases to pollute or corrode, for example, electronic components and to cause, for example, the malfunction of products such as electronic appliances.

As double-sided pressure-sensitive adhesive sheets to solve the problem, there is known a double-sided pressure-sensitive adhesive sheet which uses a non-silicone release liner containing no silicone compound and which is less polluting (being less polluting due to silicone compounds) (see Patent Literature (PTL) 1). There is also known a double-sided pressure-sensitive adhesive sheet which uses a non-silicone release liner and includes a plastic film substrate having a specific thickness as an essential constituent, and which thereby is less polluting and has satisfactory workability (see PTL 2). In addition, by configuring the plastic film substrate to have a further smaller thickness, there is provided a double-sided pressure-sensitive adhesive sheet which has improved bump absorbability (see PTL 2). Polyolefin release liners and fluorine release liners are disclosed as exemplary non-silicone release liners for use in these double-sided pressure-sensitive adhesive sheets.

### CITATION LIST

### Patent Literature

PTL 1: Japanese Patent No. 3901490
PTL 2: Japanese Unexamined Patent Application Publication (JP-A) No. 2009-74060

### SUMMARY OF INVENTION

### Technical Problem

However, of the non-silicone release liners, polyolefin release liners have relatively inferior thermal stability and solvent resistance and may thereby suffer from problems such that, when a pressure-sensitive adhesive is directly applied to the release liner and dried to form a pressure-sensitive adhesive layer thereon, the pressure-sensitive adhesive layer may not be peeled off from the release liner typically under some drying conditions. This impedes the manufacture of a double-sided pressure-sensitive adhesive sheet by a transfer process in which a pressure-sensitive adhesive layer is once formed on a release liner, and the formed pressure-sensitive adhesive layer is affixed to a plastic film substrate. Particularly when having a small thickness, the plastic film substrate is susceptible to rupture typically manufactured under some conditions, and this may impede the manufacture of a double-sided pressure-sensitive adhesive sheet even by a direct coating process in which a pressure-sensitive adhesive is directly applied to the plastic film substrate to form a pressure-sensitive adhesive layer thereon. In this case, the double-sided pressure-sensitive adhesive sheet shows remarkably low productivity.

On the other hand, of the non-silicone release liners, fluorine release liners are expensive and are thereby disadvantageous in cost.

To solve the above-mentioned problems, demands have been made to provide a double-sided pressure-sensitive adhesive sheet which is less polluting even though it includes silicone release liners which have good thermal stability and satisfactory solvent resistance and are manufacturable at relatively low cost. The double-sided pressure-sensitive adhesive sheet is also required to have excellent workability.

Accordingly, an object of the present invention is to provide a double-sided pressure-sensitive adhesive sheet for fixing a flexible printed circuit board, which is a double-sided pressure-sensitive adhesive sheet including silicone release liners, but is less polluting and has excellent workability. As used herein a “property by which pollution or contamination by silicone compounds is reduced” may be referred to as (being) “less polluting.”

### Solution to Problem

After intensive investigations, the present inventors have found a double-sided pressure-sensitive adhesive sheet which includes a pressure-sensitive adhesive unit including a substrate and pressure-sensitive adhesive layers present on or above both sides of the substrate; and silicone release liners present on or above both sides of the pressure-sensitive adhesive unit, in which the pressure-sensitive adhesive layers each have a specific composition, the pressure-sensitive adhesive unit has a thickness at a specific level or below, and the double-sided pressure-sensitive adhesive sheet, when heated, evolves siloxane gases in an amount at a specific level or below. The present inventors have found that this double-sided pressure-sensitive adhesive sheet is less polluting and has excellent workability and usable for fixing a flexible printed circuit board. The present invention has been made based on these findings.

Specifically, the present invention provides, in an aspect, a double-sided pressure-sensitive adhesive sheet for fixing a flexible printed circuit board, which includes at least a pressure-sensitive adhesive unit including a substrate and pressure-sensitive adhesive layers present on or above both sides of the substrate; and silicone release liners present on or above both surfaces of the pressure-sensitive adhesive unit, in which the pressure-sensitive adhesive layers each include an acrylic polymer based on, as an essential monomer component, at least one alkyl (meth)acrylate whose alkyl moiety being a linear or branched-chain alkyl group having 1 to 14 carbon atoms, the pressure-sensitive adhesive unit has a thickness of 60 μm or less, and the adhesive sheet evolves a siloxane gas or gases, if any, in a total amount of 1 ng/cm² or less when heated at 120° C. for 10 minutes.

In a preferred embodiment of the double-sided pressure-sensitive adhesive sheet for fixing a flexible printed circuit board, the substrate is a plastic film substrate having a thickness of 10 μm or less, and each of the pressure-sensitive adhesive layers has a thickness of 20 μm or more.

In another preferred embodiment of the double-sided pressure-sensitive adhesive sheet for fixing a flexible printed circuit board, the silicone release liners are release liners each including at least a silicone release layer, and the silicone release layer is provided in a mass of coating of 0.3 g/m² or less.

In still another embodiment, the double-sided pressure-sensitive adhesive sheet for fixing a flexible printed circuit board outgases, if any, in a total amount of 1 μg/cm² or less when heated at 120° C. for 10 minutes.

The double-sided pressure-sensitive adhesive sheet for fixing a flexible printed circuit board preferably has a gap height as defined below of 1.5 mm or less;

Gap height: A test specimen is prepared by affixing one adhesive face of the double-sided pressure-sensitive adhesive sheet to an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-sided pressure-sensitive adhesive sheet is affixed to an adherend through compression bonding using a roll laminator, where the adherend is a sheet prepared by affixing a polyimide film to a polypropylene sheet 2 mm thick, and the other adhesive face is affixed to the polyimide film of the adherend; the resulting article is left stand at 23° C. for 24 hours, thereafter heated at 70° C. for 2 hours, and the height or distance (mm) of an end of the test specimen lifted or raised from the adherend surface is measured and defined as the “gap height” (mm).

In yet another preferred embodiment of the double-sided pressure-sensitive adhesive sheet for fixing a flexible printed circuit board, each of the pressure-sensitive adhesive layers has a gel fraction of from 10% to 60%.

The present invention provides, in another aspect, a method for manufacturing the double-sided pressure-sensitive adhesive sheet for fixing a flexible printed circuit board, the method including at least the steps of applying a pressure-sensitive adhesive composition to a silicone release liner to form a pressure-sensitive adhesive layer thereon; and affixing the pressure-sensitive adhesive layer to a surface of a substrate.

### Advantageous Effects of Invention

The double-sided pressure-sensitive adhesive sheet for fixing a flexible printed circuit board according to the present invention includes silicone release liners and can thereby be manufactured with high productivity even by a transfer process, in which a pressure-sensitive adhesive composition is directly applied to the silicone release liners to form pressure-sensitive adhesive layers thereon, and the pressure-sensitive adhesive layers are affixed to a substrate. The double-sided pressure-sensitive adhesive sheet for fixing a flexible printed circuit board is satisfactorily less polluting and has excellent workability even through it is a double-sided pressure-sensitive adhesive sheet including silicone release liners. When the double-sided pressure-sensitive adhesive sheet is used for fixing a flexible printed circuit board typically to a cabinet to give a product, the advantageous effects allow the product to be obtained with higher productivity and to have higher quality.

### BRIEF DESCRIPTION OF DRAWINGS

FIG. 1 is a schematic cross-sectional view illustrating a double-sided pressure-sensitive adhesive sheet for fixing a flexible printed circuit board as an embodiment of the present invention.

FIG. 2 is an explanatory drawing (schematic cross-sectional view) illustrating the multilayer structure of a FPC used in testing for bump absorbability.

FIG. 3 is an explanatory drawing (plan view viewed from the base film layer side) illustrating how the FPC and a double-sided pressure-sensitive adhesive sheet (test sample) are arranged and affixed in the testing for bump absorbability.

### DESCRIPTION OF EMBODIMENTS

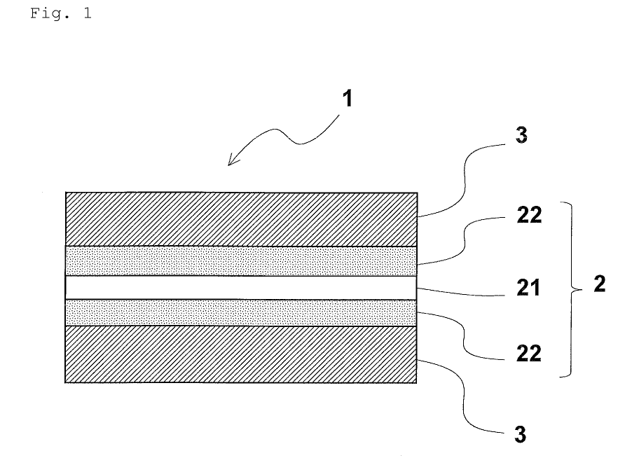

A double-sided pressure-sensitive adhesive sheet for fixing a flexible printed circuit board (FPC) according to the present invention is also hereinafter referred to as a “double-sided pressure-sensitive adhesive sheet according to the present invention” or simply referred to as a “double-sided-pressure-sensitive adhesive sheet.” The double-sided pressure-sensitive adhesive sheet at least includes two silicone release liners; and a pressure-sensitive adhesive unit located between the pressure-sensitive adhesive layers. FIG. 1 is a schematic cross-sectional view illustrating an embodiment of the double-sided pressure-sensitive adhesive sheet. The double-sided pressure-sensitive adhesive sheet 1 includes two silicone release liners 3; and a pressure-sensitive adhesive unit (portion other than the release liners) 2 located between the silicone release liners 3. The pressure-sensitive adhesive unit includes two pressure-sensitive adhesive layers 22; and a substrate 21 located between the pressure-sensitive adhesive layers 22. As used herein the term “double-sided pressure-sensitive adhesive sheet” also includes one in the form of a tape, namely includes a “double-sided pressure-sensitive adhesive tape.” Also as used herein the term “pressure-sensitive adhesive unit” refers to a portion of the double-sided pressure-sensitive adhesive sheet, which portion is affixed to adherends upon use, i.e., it generally refers to a portion of the double-sided pressure-sensitive other than the release liners.

[Pressure-Sensitive Adhesive Unit]

The pressure-sensitive adhesive unit in the double-sided pressure-sensitive adhesive sheet has a multilayer structure including a substrate, and present on or above both sides thereof, pressure-sensitive adhesive layers, as mentioned above. Specifically, the pressure-sensitive adhesive unit is a double-sided pressure-sensitive adhesive unit in which both surfaces serve as adhesive faces (surfaces of pressure-sensitive adhesive layers). The pressure-sensitive adhesive unit may further include one or more other layers (e.g., an intermediate layer and an under coat) in addition to the substrate and pressure-sensitive adhesive layers, within a range not adversely affecting the advantageous effects of the present invention. The substrate may be laminated with each of the pressure-sensitive adhesive layers directly, or indirectly with the interposition of another layer such as an intermediate layer.

The pressure-sensitive adhesive unit has a thickness of 60 μm or less, preferably from 10 to 60 μm, more preferably from 25 to 60 μm, and furthermore preferably from 40 to 60 μm. Control of the pressure-sensitive adhesive unit to have a thickness of 60 μm or less is advantageous for reduction in thickness and size of a product (e.g., HDD) which is manufactured through fixing a FPC using the double-sided pressure-sensitive adhesive sheet. In contrast, control of the pressure-sensitive adhesive unit to have a thickness of 10 μm or more may allow the double-sided pressure-sensitive adhesive sheet to have more satisfactory workability, handleability, and adhesiveness. As used herein the term “thickness of the pressure-sensitive adhesive unit” refers to a thickness (distance) from one adhesive face (surface of one of the pressure-sensitive adhesive layers) of the pressure-sensitive adhesive unit to the other adhesive face.

(Substrate)

The substrate in the pressure-sensitive adhesive unit of the double-sided pressure-sensitive adhesive sheet is a supporting substrate or carrier for pressure-sensitive adhesive layers and plays a role to improve the workability and handleability of the double-sided pressure-sensitive adhesive sheet. The substrate may be any of substrates generally used as substrates or carriers for pressure-sensitive adhesive sheets. Examples thereof include plastic films (plastic film substrates) composed typically of polyester resins, olefinic resins, polyvinyl chloride) resins, acrylic resins, vinyl acetate resins, amide resins, polyimide resins, poly(ether ether ketone)s, and poly(phenylene sulfide)s; fibrous substrates such as nonwoven fabrics; paper substrates such as paper of every type; and metallic substrates such as metallic foils. Of these, preferred are plastic films, of which polyester films and polyolefin films are preferred, and poly(ethylene terephthalate) films (PET films) are more preferred, for their low cost and suitable rigidity. The substrate may have a single-layer structure or multilayer structure.

To have higher adhesion to the pressure-sensitive adhesive layers, the substrate may have undergone a common surface treatment according to necessity. Exemplary surface treatments include chromate treatment, exposure to ozone, exposure to flame, exposure to a high-voltage electric shock, treatment with ionizing radiation, and other oxidation treatments by chemical or physical processes. In addition or alternatively, the surfaces of the substrate may have undergone another treatment such as coating with a primer.

Though not critical, the thickness of the substrate (particularly plastic film substrate) is typically preferably 10 μm or less (e.g., from 2 to 10 μm), and more preferably from 4 to 8 μm. The control of the substrate to have a thickness of 10 μm or less allows the double-sided pressure-sensitive adhesive sheet to have more satisfactory “bump absorbability.” As used herein the term “bump absorbability” (also referred to as “bump absorptivity”) refers to such a property that the double-sided pressure-sensitive adhesive sheet, when applied to adherends, can readily and satisfactorily conform or fit the configurations of bumps in the adherends. Such a double-sided pressure-sensitive adhesive sheet having satisfactory bump absorbability, when affixed typically to a FPC or another adherend bearing a fine pattern (fine traces) on its surface, more satisfactorily adheres to the adherend even when the adhesive sheet is affixed to the adhered under a weak (small) pressing force, because the pressure-sensitive adhesive layers can fit and come into minute spaces between the traces. The advantageous effect is obtained because the thicknesses of the pressure-sensitive adhesive layers are to be relatively larger than the thickness of the substrate. Thus, the double-sided pressure-sensitive adhesive sheet, when having a thickness of the substrate of 10 μm or less, is resistant to the formation of interstices or gaps between an adherend and the pressure-sensitive adhesive layer even when the adherend bears a fine pattern and the adhesive sheet is affixed thereto under a small pressing force. The substrate herein is protected from having excessively high rigidity, and this suppresses a “gap” (pop-off) after affixation. In addition, the use of such a thin substrate may become advantageous for the reduction in size and thickness of a product in which a FPC is fixed using the double-sided pressure-sensitive adhesive sheet. In contrast, control of the thickness of the substrate to be 2 μm or more may allow the double-sided pressure-sensitive adhesive sheet to have more satisfactory handleability.

(Pressure-Sensitive Adhesive Layers)

The pressure-sensitive adhesive layers in the pressure-sensitive adhesive unit of the double-sided pressure-sensitive adhesive sheet are each based on an acrylic polymer or polymers. Specifically, the pressure-sensitive adhesive layers include one or more acrylic polymers as base polymers. Though not critical, the content of acrylic polymer or polymers (the acrylic polymer or polymers are hereinafter also simply referred to as “acrylic polymer”) in each pressure-sensitive adhesive layer is preferably 80 percent by weight or more (80 to 100 percent by weight), and more preferably from 90 to 99 percent by weight, based on the total amount (100 percent by weight) of the pressure-sensitive adhesive layer. Each of different acrylic polymers may be used alone or in combination.

Though not critical and may vary depending on the technique for the formation thereof, the pressure-sensitive adhesive layers may each be formed from an acrylic pressure-sensitive adhesive composition containing an acrylic polymer as an essential component; or from an acrylic pressure-sensitive adhesive composition containing, as an essential component, a mixture of monomers for the formation of an acrylic polymer (hereinafter also referred to as a “monomer mixture”) or a partial polymer of the monomer mixture. Examples of the former composition include, but are not limited to, so-called solvent pressure-sensitive adhesive compositions; and examples of the latter composition include, but are not limited to, so-called active-energy-ray-curable pressure-sensitive adhesive compositions. The acrylic pressure-sensitive adhesive composition may further contain crosslinking agents and other additives according to necessity.

As used herein the term “pressure-sensitive adhesive composition” also means and includes a “composition for the formation of pressure-sensitive adhesive layers.” Also as used herein the term “monomer mixture” refers to a mixture containing only a monomer component or components for the formation of an acrylic polymer. The term “partial polymer” refers to a composition in which one or more of components constituting the monomer mixture have been partially polymerized.

The acrylic polymer plays a role of exhibiting tackiness as the base polymer for the pressure-sensitive adhesive layers. The acrylic polymer is a polymer formed from, as an essential monomer component, one or more alkyl (meth)acrylates whose alkyl moiety being a linear or branched-chain alkyl group having 1 to 14 carbon atoms (hereinafter also referred to as “(meth)acrylic C₁-C₁₄ alkyl ester(s)”). The monomer components for forming the acrylic polymer may further include, in addition to (meth)acrylic C₁₄ alkyl esters, one or more monomers each containing a polar group (hereinafter also referred to as “polar-group-containing monomer(s)”) and/or one or more additional monomer components other than the (meth)acrylic C₁-C₁₄ alkyl esters and polar-group-containing monomers. Each of different (meth)acrylic C₁-C₁₄ alkyl esters, each of different polar-group-containing monomers, and each of different additional monomer components may be used alone or in combination. As used herein the term “(meth)acrylic” refers to “acrylic” and/or “methacrylic”, and the same is true for other descriptions.

The (meth)acrylic C₁-C₁₄ alkyl esters are alkyl (meth)acrylates whose alkyl moiety being a linear or branched-chain alkyl group having 1 to 14 carbon atoms, and examples thereof include methyl (meth)acrylates, ethyl (meth)acrylates, propyl (meth)acrylates, isopropyl (meth)acrylates, n-butyl (meth)acrylates (butyl (meth)acrylates), isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth)acrylates, 2-ethylhexyl (meth)acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth)acrylates, tridecyl (meth)acrylates, and tetradecyl (meth)acrylates. Among them, alkyl (meth)acrylates whose alkyl moiety being a linear or branched-chain alkyl group having 2 to 10 carbon atoms are preferred, of which 2-ethylhexyl acrylate, n-butyl acrylate, and isooctyl acrylate are more preferred from the viewpoint of temperature characteristics (glass transition temperature Tg).

The content of the (meth)acrylic C₁-C₁₄ alkyl esters is preferably from 50 to 99 percent by weight, more preferably from 80 to 97 percent by weight, and furthermore preferably from 90 to 95 percent by weight, based on the total amount (100 percent by weight) of monomer components for the formation of the acrylic polymer. The acrylic polymer, when having a content of (meth)acrylic C₁-C₁₄ alkyl esters of 50 percent by weight or more, may tend to exhibit properties as an acrylic polymer, such as tackiness. The acrylic polymer, when having a content of (meth)acrylic C₁-C₁₄ alkyl esters of 99 percent by weight or less, may exhibit improved adhesiveness, because sufficient amount of polar-group-containing monomers may be copolymerized.

The pressure-sensitive adhesive layers in the double-sided pressure-sensitive adhesive sheet are preferably pressure-sensitive adhesive layers each including an acrylic polymer, which acrylic polymer includes at least one selected from the group consisting of 2-ethylhexyl acrylate, acrylate, and isooctyl acrylate as an essential monomer component, in which the total content of 2-ethylhexyl acrylate, n-butyl acrylate, and isooctyl acrylate is 50 to 99 percent by weight based on the total amount (100 percent by weight) of monomer components for the formation of the acrylic polymer.

The polar-group-containing monomers are monomers each intramolecularly having one or more polar groups, of which ethylenically unsaturated monomers are preferred. Examples of polar-group-containing monomers include carboxyl-containing monomers such as (meth)acrylic acids, itaconic acid, maleic acid, fumaric acid, crotonic acid, and isocrotonic acid, as well as acid-anhydride-group-containing monomers such as maleic anhydride and itaconic anhydride; hydroxyl-containing monomers such as hydroxyalkyl (meth)acrylates (e.g., 2-hydroxyethyl (meth)acrylates, 3-hydroxypropyl (meth)acrylates, 4-hydroxybutyl (meth)acrylates, and 6-hydroxyhexyl (meth)acrylates), vinyl alcohol, and allyl alcohol; amido-containing monomers such as (meth)acrylamides, N,N-dimethyl(meth)acrylamides, N-methylol(meth)acrylamides, N-methoxymethyl(meth)acrylamides, N-butoxymethyl(meth)acrylamides, and N-hydroxyethyl(meth)acrylamides; amino-containing monomers such as aminoethyl (meth)acrylates, dimethylaminoethyl (meth)acrylates, and t-butylaminoethyl (meth)acrylates; glycidyl-containing monomers such as glycidyl (meth)acrylates and methylglycidyl (meth)acrylates; cyano-containing monomers such as acrylonitrile and methacrylonitrile; heterocycle-containing vinyl monomers such as N-vinyl-2-pyrrolidone, (meth)acryloylmorpholine, N-vinylpiperidone, N-vinylpiperazine, N-vinylpyrrole, and N-vinylimidazole; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate. Each of different polar-group-containing monomers may be used alone or in combination. Among them, carboxyl-containing monomers and hydroxyl-containing monomers are preferred, of which acrylic acid (AA) and 4-hydroxybutyl acrylate (4HBA) are more preferred.

The content of polar-group-containing monomers is preferably from 1 to 30 percent by weight, and more preferably from 3 to 20 percent by weight, based on the total amount (100 percent by weight) of monomer components for the formation of the acrylic polymer. The acrylic pressure-sensitive adhesive composition, when having a content of polar-group-containing monomers of 1 percent by weight or more, may exhibit higher cohesive strength, and this allows the pressure-sensitive adhesive layers to show improved shearing adhesive strength and bond strength. In contrast, the acrylic pressure-sensitive adhesive composition, when having a content of polar-group-containing monomers of 30 percent by weight or less, may show a suitable cohesive strength being not excessively high, and this allows the pressure-sensitive adhesive layers to have higher adhesive strengths. Of the polar-group-containing monomers, carboxyl-containing monomers (of which acrylic acid is preferred) may be used in a content of preferably from 1 to 20 percent by weight and more preferably from 3 to 10 percent by weight, based on the total amount (100 percent by weight) of monomer components for the formation of the acrylic polymer, from the viewpoint of adhesiveness. Independently, hydroxyl-containing monomers (of which 4-hydroxybutyl acrylate is preferred) may be used in a content of preferably from 0.01 to 10 percent by weight and more preferably from 0.03 to 5 percent by weight based on the total amount (100 percent by weight) of monomer components for the formation of the acrylic polymer, from the viewpoint of cross-linking properties.

The additional monomer components are monomers other than (meth)acrylic C₁-C₁₄ alkyl esters and polar-group-containing monomers, of which ethylenically unsaturated monomers are preferred. Examples of such additional monomer components include alkyl (meth)acrylates whose alkyl moiety being a linear or branched-chain alkyl group having 15 or more carbon atoms, such as pentadecyl (meth)acrylates, hexadecyl (meth)acrylates, heptadecyl (meth)acrylates, octadecyl (meth)acrylates, nonadecyl (meth)acrylates, and eicosyl (meth)acrylates; (meth)acrylic acid esters each having an alicyclic hydrocarbon group, such as cyclopentyl (meth)acrylates, cyclohexyl (meth)acrylates, and isobornyl (meth)acrylates; aryl (meth)acrylates such as phenyl (meth)acrylates; vinyl esters such as vinyl acetate and vinyl propionate; aromatic vinyl compounds such as styrene and vinyltoluene; olefins or dienes, such as ethylene, butadiene, isoprene, and isobutylene; vinyl ethers such as vinyl alkyl ethers; and vinyl chloride. Examples of the additional monomer components further include multifunctional monomers such as hexanediol di(meth)acrylates, butanediol di(meth)acrylates, (poly)ethylene glycol di(meth)acrylates, (poly) propylene glycol di(meth)acrylates, neopentyl glycol di(meth)acrylates, pentaerythritol di(meth)acrylates, pentaerythritol tri(meth)acrylates, dipentaerythritol hexa(meth)acrylates, trimethylolpropane tri(meth)acrylates, tetramethylolmethane tri(meth)acrylates, allyl (meth)acrylates, vinyl (meth)acrylates, divinylbenzene, epoxy acrylates, polyester acrylates, and urethane acrylates. Each of different additional monomer components may be used alone or in combination.

The acrylic polymer may be prepared by polymerizing (copolymerizing) the monomer component(s) according to a known or customary polymerization process. Exemplary polymerization processes for the acrylic polymer include solution polymerization, emulsion polymerization, bulk polymerization, and polymerization through the application of active energy rays such as ultraviolet rays. Of these, solution polymerization and polymerization through the application of active energy rays are preferred from the viewpoints of cost and mass productivity. Polymerization of the acrylic polymer may employ suitable components chosen from among known or common ones according to the polymerization process to be used. Examples of such components include polymerization initiators, chain-transfer agents, emulsifiers, and solvents.

One or more polymerization initiators such as thermal polymerization initiators and active-energy-ray-polymerization initiators (hereinafter also referred to as “photopolymerization initiator(s)” or “photoinitiator(s)”) may be used in polymerization of the acrylic polymer. Each of different polymerization initiators may be used alone or in combination.

Examples of the photoinitiators usable herein include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators. Though not critical, the amount of photoinitiators is typically preferably from 0.01 to 0.2 part by weight, and more preferably from 0.05 to 0.15 part by weight, per 100 parts by weight of the total amount of monomer components for the formation of the acrylic polymer.

Exemplary benzoin ether photoinitiators include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Exemplary acetophenone photoinitiators include 2,2-diethoxyacetophenone, 2,2-dimethoxy-2-phenylacetophenone, 1-hydroxycyclohexylphenyl ketone, 4-phenoxydichloroacetophenone, and 4-(t-butyl)dichloroacetophenone. Exemplary α-ketol photoinitiators include 2-methyl-2-hydroxypropiophenone and 1-[4-(2-hydroxyethyl)phenyl]-2-methylpropan-1-one. Exemplary aromatic sulfonyl chloride photoinitiators include 2-naphthalenesulfonyl chloride. Exemplary photoactive oxime photoinitiators include 1-phenyl-1,1-propanedione-2-(o-ethoxycarbonyl)-oxime. Exemplary benzoin photoinitiators include benzoin. Exemplary benzil photoinitiators include benzil (dibenzoyl). Exemplary benzophenone photoinitiators include benzophenone, benzoylbenzoic acid, 3,3′-dimethyl-4-methoxybenzophenone, polyvinylbenzophenones, and α-hydroxycyclohexyl phenyl ketone. Exemplary ketal photoinitiators include benzyl dimethyl ketal. Exemplary thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

When the acrylic polymer is polymerized through solution polymerization, azo initiators are preferably used as the polymerization initiators, of which the azo initiators disclosed in Japanese Unexamined Patent Application Publication (JP-A) No. 2002-69411 are especially preferred. Such azo initiators are preferred because their decomposed products are unlikely to remain as components causing outgassing (gassing induced by heating) from the acrylic polymer. Examples of the azo initiators include 2,2′-azobisisobutyronitrile (hereinafter also referred to as AIBN), 2,2′-azobis-2-methylbutyronitrile (hereinafter also referred to as AMBN), dimethyl 2,2′-azobis(2-methylpropionate), and 4,4′-azobis-4-cyanovaleric acid. The amount of azo initiators is preferably from 0.05 to 0.5 part by weight, and more preferably from 0.1 to 0.3 part by weight, per 100 parts by weight of the total amount of monomer components for the formation of the acrylic polymer.

When the acrylic polymer is polymerized through solution polymerization, solvents such as known or customary organic solvents may be used. Exemplary organic solvents usable herein include ester solvents such as ethyl acetate and methyl acetate; ketone solvents such as acetone and methyl ethyl ketone; alcohol solvents such as methanol, ethanol, and butanol; hydrocarbon solvents such as cyclohexane, hexane, and heptane; and aromatic solvents such as toluene and xylenes. Each of different organic solvents may be used alone or in combination.

Though not critical, the acrylic polymer has a weight-average molecular weight (Mw) of typically preferably from 30×10⁴ to 200×10⁴, more preferably from 60×10⁴ to 150×10⁴, and furthermore preferably from 70×10⁴ to 150×10⁴. The acrylic polymer, when having a weight-average molecular weight of 30×10⁴ or more, may show improved thermal stability and higher adhesive properties. In contrast, the acrylic polymer, when having a weight-average molecular weight of 200×10⁴ or less, may show improved coatability. The weight-average molecular weight may be controlled typically by the types and amounts of polymerization initiators, the temperature and duration of the polymerization, and the concentrations and adding rates (dropping rates) of monomers in the polymerization.

The acrylic pressure-sensitive adhesive composition for the formation of the pressure-sensitive adhesive layers in the double-sided pressure-sensitive adhesive sheet preferably contains one or more crosslinking agent for the purpose typically of controlling the gel fraction (proportion of components insoluble in the solvent) of the pressure-sensitive adhesive layers. Examples of the crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Each of different crosslinking agents may be used alone or in combination. In a preferred embodiment, one or more isocyanate crosslinking agents are used as essential crosslinking agents, and in a more preferred embodiment, one or more isocyanate crosslinking agents are used in combination with one or more epoxy crosslinking agents.

Exemplary isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, hydrogenated xylene diisocyanate, and hydrogenated xylylene diisocyanate; and aromatic polyisocyanates such as 2,4-tolylene diisocyanate, 2,6-tolylene diisocyanate, 4,4′-diphenylmethane diisocyanate, and xylylene diisocyanate; as well as an adduct of tolylene diisocyanate with trimethylolpropane [trade name “CORONATE L” supplied by Nippon Polyurethane Industry Co., Ltd.] and an adduct of hexamethylene diisocyanate with trimethylolpropane [trade name “CORONATE HL” supplied by Nippon Polyurethane Industry Co., Ltd.].

Examples of the epoxy crosslinking agents include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl tris(2-hydroxyethyl)isocyanurate, resorcinol diglycidyl ether, bisphenol-S diglycidyl ether, and epoxy resins each having two or more epoxy groups per one molecule. Exemplary commercial products usable as epoxy crosslinking agents include a product under the trade name “TETRAD C” supplied by Mitsubishi Gas Chemical Company, Inc.

In the case of an acrylic pressure-sensitive adhesive composition containing an acrylic polymer as an essential component, the content of crosslinking agents in the acrylic pressure-sensitive adhesive composition is preferably from 0.15 to 1.05 parts by weight, more preferably from 0.2 to 1.05 parts by weight, and furthermore preferably from 0.2 to 0.5 part by weight, per 100 parts by weight of the acrylic polymer.

Of the crosslinking agents, the isocyanate crosslinking agents may be used in a content of preferably from 0.15 to 1 part by weight, more preferably from 0.2 to 1 part by weight, and furthermore preferably from 0.2 to 0.5 part by weight, per 100 parts by weight of the acrylic polymer. The control of the content of isocyanate crosslinking agents to be 0.15 part by weight or more may allow the pressure-sensitive adhesive layers to have improved anchoring activity to adherends, and this may reduce the gap height or suppress “gap” formation. In contrast, the control of the content of isocyanate crosslinking agents to be 1 part by weight or less may allow the pressure-sensitive adhesive layers to have not excessively high gel fractions to thereby show smaller repulsive force upon bending of the pressure-sensitive adhesive layers, and this may reduce the gap height or suppress “gap” formation.

Isocyanate crosslinking agents, if contained in a relatively low content, may not sufficiently help the pressure-sensitive adhesive layers to have controlled gel fractions, because isocyanate crosslinking agents easily undergo crosslinking by themselves. In this case, one or more epoxy crosslinking agents are preferably used in combination with the isocyanate crosslinking agents. The content of such epoxy crosslinking agents is preferably from 0 to 0.05 part by weight, and more preferably from 0 to 0.02 part by weight, per 100 parts by weight of the acrylic polymer. The control of the content of epoxy crosslinking agents to be 0.05 part by weight or less allows the pressure-sensitive adhesive layers to have gel fractions being not excessively high and to show smaller repulsive force upon bending of the pressure-sensitive adhesive layers, and this may reduce the gap height or suppress “gap” formation.

In the case of an acrylic pressure-sensitive adhesive composition containing a monomer mixture or a partial polymer thereof as an essential component, preferred ranges of the contents of crosslinking agents are indicated by replacing the above-mentioned base “100 parts by weight of the acrylic polymer” with “per 100 parts by weight of the total amount of monomer components for the formation of the acrylic polymer.” Specifically, the content of crosslinking agents in the acrylic pressure-sensitive adhesive composition is preferably from 0.15 to 1.05 parts by weight, more preferably from 0.2 to 1.05 parts by weight, and furthermore preferably from 0.2 to 0.5 part by weight, per 100 parts by weight of the total amount of monomer components for the formation of the acrylic polymer. In particular, the content of isocyanate crosslinking agents is preferably from 0.15 to 1 part by weight, more preferably from 0.2 to 1 part by weight, and furthermore preferably from 0.2 to 0.5 part by weight, per 100 parts by weight of the total amount of monomer components for the formation of the acrylic polymer; and the content of epoxy crosslinking agents is preferably from 0 to 0.05 part by weight, and more preferably from 0 to 0.02 part by weight, per 100 parts by weight of the total amount of monomer components for the formation of the acrylic polymer.

The acrylic pressure-sensitive adhesive composition may further contain, in addition to the above-mentioned components, known additives according to necessity, within ranges not adversely affecting properties and advantageous effects of the present invention. Exemplary additives herein include age inhibitors, fillers, colorants (e.g., pigments and dyestuffs), ultraviolet absorbers, antioxidants, plasticizers, softeners, surfactants, and antistatic agents.

In a preferred embodiment, the acrylic pressure-sensitive adhesive composition contains substantially no tackifier resin. As used herein the phrase “contains substantially no” refers to that the component in question is not actively incorporated, except for being inevitably contaminated. Accordingly, the content of such tackifier resins is preferably less than 1 percent by weight, and more preferably less than 0.1 percent by weight, based on the total weight (100 percent by weight) of the pressure-sensitive adhesive layer. The acrylic pressure-sensitive adhesive composition, when containing substantially no tackifier resin, may give pressure-sensitive adhesive layers which cause less outgassing upon heating. Specific examples of the tackifier resins include rosin derivative resins, polyterpene resins, petroleum resins, and oil-soluble phenol resins.

Though not critical, the thickness of each pressure-sensitive adhesive layer (thickness of one pressure-sensitive adhesive layer provided on one side of the substrate) is preferably 20 μm or more (e.g., from 20 to 29 μm), more preferably from 22 to 29 μm, and furthermore preferably from 23 to 29 μm. The pressure-sensitive adhesive layers, when each having a thickness of 20 μm or more, may easily exhibit satisfactory adhesiveness and may show improved bump absorbability. In contrast, the pressure-sensitive adhesive layers, when each having a thickness of 29 μm or less, give a double-sided pressure-sensitive adhesive sheet being not excessively thick, and this is advantageous in reduction of thickness and size of a product produced through fixing a FPC using the double-sided pressure-sensitive adhesive sheet. Each of the pressure-sensitive adhesive layers may independently have a single-layer structure or multilayer structure.

Though not critical, the pressure-sensitive adhesive layers have gel fractions of typically preferably from 10% to 60% (percent by weight), more preferably from 10% to 50%, and furthermore preferably from 15% to 50%. The pressure-sensitive adhesive layers, when having gel fractions of 10% or more, may show higher cohesive strengths, and this may prevent cohesive failure or may improve adhesiveness and reworking properties (e.g., prevention of adhesive residue when the adhesive sheet is peeled off from the adherends). In contrast, the pressure-sensitive adhesive layers, when having gel fractions of 60% or less, may show smaller repulsive force due to bending of the pressure-sensitive adhesive layers, and the double-sided pressure-sensitive adhesive sheet may show a smaller gap height and less suffer from “gap” formation typically in bumps even after undergoing a heating process. In addition, the double-sided pressure-sensitive adhesive sheet may show more satisfactory bump absorbability. The gel fractions may be controlled typically by regulating the monomer composition of the acrylic polymer; and the types and contents of crosslinking agents.

The gel fractions (contents of components insoluble in solvents) are values determined according to the following “method for measuring gel fraction.”

Method for Measuring Gel Fraction

About 0.1 g of a pressure-sensitive adhesive layer of the double-sided pressure-sensitive adhesive sheet is sampled to give a sample, the sample is covered by a porous tetrafluoroethylene sheet (supplied by Nitto Denko Corporation under the trade name “NTF 1122”) having an average pore size of 0.2 μm, tied with a kite string, the weight of the resulting article is measured, and this weight is defined as a “weight before immersion.” The “weight before immersion” is the total weight of the pressure-sensitive adhesive layer (the sampled pressure-sensitive adhesive layer), the tetrafluoroethylene sheet, and the kite string. Independently, the total weight of the tetrafluoroethylene sheet and the kite string is measured and defined as a tare weight.

Next, the sampled pressure-sensitive adhesive layer covered by the tetrafluoroethylene sheet and tied with the kite string (this article is hereinafter also referred to as “specimen”) is placed in a 50-ml vessel filled with ethyl acetate, and left stand therein at 23° C. for one week (7 days). The specimen after immersion in ethyl acetate is retrieved from the vessel, transferred into an aluminum cup, dried in a drier at 130° C. for 2 hours to remove ethyl acetate, and the weight of the resulting specimen is measured as a weight after immersion.

A gel fraction is calculated according to the following equation:

Gel fraction (percent by weight)=(A−B)/(C−B)×100 (1)

wherein “A” represents the weight after immersion; “B” represents the tare weight; and “C” represents the weight before immersion.

[Release Liners]

The double-sided pressure-sensitive adhesive sheet according to the present invention is a so-called double-separator-type double-sided pressure-sensitive adhesive sheet in which at least two release liners (separators) are arranged respectively on the both sides of the pressure-sensitive adhesive unit. The release liners are used as protecting materials for the adhesive faces, and will be removed when the double-sided pressure-sensitive adhesive sheet is applied to adherends.

The release liners in the double-sided pressure-sensitive adhesive sheet are silicone release liners each having at least a silicone release layer (layer treated with a silicone release agent). The silicone release liners may each include one or more other layers (e.g., intermediate layers and under coats) within ranges not adversely affecting the advantageous effects of the present invention, in addition to the silicone release layer. The silicone release liners in the double-sided pressure-sensitive adhesive sheet are provided so that the silicone release layers are respectively in contact with the adhesive faces (surfaces of the pressure-sensitive adhesive layers) of the pressure-sensitive adhesive unit.

Examples of the silicone release liners include, but are not limited to, release liners each having a silicone release layer on at least one side of a release liner carrier. Examples of the release liner carrier include, but are not limited to, plastic films; and materials for the plastic films include polyester resins such as poly(ethylene terephthalate)s (PETS), poly(ethylene naphthalate)s (PENs), and poly(butylene terephthalate)s (PBTs); olefinic resins each including one or more α-olefins as monomer components, such as polyethylenes (PEs), polypropylenes (PPs), polymethylpentenes (PMPs), ethylene-propylene copolymers, and ethylene-vinyl acetate copolymers (EVAs); poly(vinyl chloride)s (PVCs); vinyl acetate resins; polycarbonates (PCs); poly(phenylene sulfide)s (PPSs); amide resins such as polyamides (nylons) and wholly aromatic polyamides (aramids); polyimide resins; and poly(ether ether ketone)s (PEEKs).

Of these, plastic films composed of polyester resins (polyester films) are preferred, of which PET films are particularly preferred, from the viewpoint of their satisfactory thermal stability. Specifically, the release liners in the double-sided pressure-sensitive adhesive sheet are preferably silicone release liners each including a PET film and, arranged on at least one side thereof, a silicone release layer. The silicone release liners having such configuration excel in thermal stability and solvent resistance and are thereby resistant to problems such that the release liners are hardly peeled off from pressure-sensitive adhesive layers, even when the pressure-sensitive adhesive layers are formed by applying a pressure-sensitive adhesive composition directly to the release liners, and drying and/or curing the applied layers according to necessity. This enables easy manufacture of a double-sided pressure-sensitive adhesive sheet by the transfer process and particularly enables manufacture of a double-sided pressure-sensitive adhesive sheet with high productivity even when the double-sided pressure-sensitive adhesive sheet has a further thin substrate and is difficult to be manufactured by the direct coating process.

Though not critical, the thickness of the release liner carrier is typically preferably from 25 to 100 μm, and more preferably from 38 to 75 μm. The control of the thickness to be 25 μm or more may improve the workability, whereas the control of the thickness to be 100 μm or less may also improve the workability.

The silicone release layers are release layers each containing a silicone compound. Though not limited, the silicone release layers are preferably each formed typically from a silicone release agent. Examples of the silicone release agent include, but are not limited to, thermosetting addition silicone release agents, thermosetting condensation silicone release agents, ultraviolet-ray-curable silicone release agents, and electron-beam-curable silicone release agents. Of these, thermosetting addition silicone release agents (thermosetting addition polysiloxane release agents) are preferred from the viewpoint of adhesion to the carrier (adhesion to the release liner carrier), because these silicone release agents are cured through a thermal addition reaction-type crosslinking reaction (curing reaction) to form releasable coatings, and the resulting releasable coatings exhibit useful release properties. Each of different silicone release agents may be used alone or in combination.

The thermosetting addition silicone release agents each include an alkenyl-containing silicone and a hydrosilyl-containing silicone as essential components, in which the alkenyl-containing silicone is a polyorganosiloxane intramolecularly having an alkenyl group as a functional group, and the hydrosilyl-containing silicone is a polyorganosiloxane intramolecularly having a hydrosilyl group as a functional group.

As the alkenyl-containing silicone, preferred are polyorganosiloxanes each structurally having at least one alkenyl group bonded to a silicon atom constituting the principal chain or skeleton (e.g., a terminal silicon atom or a silicon atom inside the principal chain), of which polyorganosiloxanes each having two or more alkenyl groups bonded to silicon atom(s) constituting the principal chain or skeleton are more preferred.

Exemplary alkenyl groups in the alkenyl-containing silicone include vinyl group (ethenyl group), allyl group (2-propenyl group), butenyl group, pentenyl group, and hexenyl group. Of these, vinyl group and hexenyl group are preferred.

Exemplary polyorganosiloxanes for constituting the principal chain or skeleton of the alkenyl-containing silicone include polyalkylalkylsiloxanes (polydialkylsiloxanes) such as polydimethylsiloxanes, polydiethylsiloxanes, and polymethylethylsiloxanes; polyalkylarylsiloxanes; and copolymers each including two or more different silicon-containing monomer components, such as poly(dimethylsiloxane-diethylsiloxane)s. Among them, polydimethylsiloxanes are preferred. Specifically, the alkenyl-containing silicone is preferably a polydimethylsiloxane having vinyl group as a functional group; a polydimethylsiloxane having hexenyl group as a functional group; or a mixture of them.

As the hydrosilyl-containing silicone, preferred are polyorganosiloxanes each having at least one hydrogen atom bonded to a silicon atom constituting the principal chain or skeleton (e.g., a terminal silicon atom or a silicon atom inside the principal chain). Namely, polyorganosiloxanes each having at least one silicon atom having a Si—H bond and constituting the principal chain or skeleton are preferred. Among them, polyorganosiloxanes each having two or more hydrogen atoms bonded to silicon atom(s) constituting the principal chain or skeleton are more preferred. Preferred examples of the hydrosilyl-containing silicone include polymethylhydrogensiloxanes and poly(dimethylsiloxane-methylhydrogensiloxane)s.

The silicone release agent preferably contains one or more organic solvents. Specifically, the silicone release agent is preferably a solvent silicone release agent. Though the organic solvents are not limited, as long as capable of solving components uniformly therein, examples of thereof include hydrocarbon solvents such as cyclohexane, hexane, and heptane; aromatic solvents such as toluene and xylenes; ester solvents such as ethyl acetate and methyl acetate; ketone solvents such as acetone and methyl ethyl ketone; and alcohol solvents such as methanol, ethanol, and butanol. Each of different organic solvents may be used alone or in combination.

The silicone release agent preferably contains a catalyst (curing catalyst). Exemplary catalysts include, but are not limited to, platinum catalysts and tin catalyst. Of these, preferred is at least one platinum catalyst selected from the group consisting of chloroplatinic acid, olefin complexes of platinum, and olefin complexes of chloroplatinic acid. The platinum catalyst may also be a commercial product such as one under the trade name “PL-50T” (supplied by Shin-Etsu Chemical Co., Ltd.).

The silicone release agent may further contain a reaction inhibitor for showing satisfactory storage stability at room temperature. Exemplary reaction inhibitors usable herein include 3,5-dimethyl-hexyn-3-ol, 3-methyl-1-penten-3-ol, 3-methyl-3-penten-1-yne, and 3,5-dimethyl-3-hexen-1-yne.

Where necessary, the silicone release agent may further contain other components, such as release-controlling agents, in addition to the above-mentioned components. For example, the silicone release agent may contain any of release-controlling agents such as MQ resins; and polyorganosiloxanes which do not have an alkenyl group or hydrosilyl group, such as polydimethylsiloxanes each being endcapped with trimethylsiloxy group. Though not critical, the content of the release-controlling agent is preferably from 1 to 30 percent by weight with respect to a base component or components (e.g., both the alkenyl-containing silicone and hydrosilyl-containing silicone in the case of the thermosetting addition silicone release agent).

The silicone release agent may further contain additional components (additives) according to necessity. Examples of the additional components include, but are not limited to, fillers, antistatic agents, antioxidants, ultraviolet absorbers, plasticizers, and colorants (e.g., dyestuffs and pigments).

Though not critical, the silicone release agent has a solids concentration of typically preferably from 0.1 to 5 percent by weight, and more preferably from 0.5 to 2 percent by weight. The control of the solids concentration to be 0.1 percent by weight or more enables a stable releasing treatment. In contrast, the control of the solids concentration to be 5 percent by weight or less enables coating of the silicone release agent to form a thin release layer. The coating of the silicone release agent to form a thin release layer suppresses the silicone compound from migrating into the pressure-sensitive adhesive layers.

The silicone release layer may be formed, for example, by a process of applying (coating) the silicone release agent to the release liner carrier, and drying and/or curing the applied agent.

Though not critical, the silicone release agent for the formation of the silicone release layer may be applied in a mass of coating typically in terms of solids content of the silicone release agent of preferably 0.3 g/m² or less (e.g., from 0.02 to 0.3 g/m²), more preferably from 0.05 to 0.2 g/m², and furthermore preferably from 0.05 to 0.15 g/m². The control of the mass of coating to be 0.3 g/m² or less may reduce the amount of silicone compounds (particularly low-molecular-weight silicone compounds) to be attached to the adhesive faces or to be absorbed by the pressure-sensitive adhesive layers and may thereby suppress the evolution of siloxane gases. In contrast, the control of the mass of coating to be 0.02 g/m² or more provides a sufficient release force.

The coating (application) of the silicone release agent may employ a customary coater such as gravure roll coater, reverse roll coater, kiss roll coater, dip roll coater, bar coater, knife coater, or spray coater.

As has been described, after being applied to the surface of the release liner carrier, the silicone release agent is dried and/or cured. Heating conditions for the drying and/or curing are not limited, but the heating may be performed, for example, preferably at 100° C. or higher (e.g., from 100° C. to 170° C.) for 1 minute or longer (e.g., from 1 to 3 minutes), and more preferably at 120° C. to 150° C. for 1 to 2 minutes. The applied silicone release agent, when dried and/or cured under the above heating conditions, may allow the silicone release layer to have higher adhesion to the release liner carrier, and this may suppress the evolution of siloxane gas.

The silicone release layer after the drying and/or curing process is preferably, but not necessarily, aged (matured). The aging may be performed under any conditions not limited, but is preferably performed at 20° C. to 40° C. for 12 to 72 hours. The silicone release layer, when aged under the conditions, may have a higher degree of curing, and this may suppress the evolution of siloxane gas.

The silicone release liners in the double-sided pressure-sensitive adhesive sheet may be formed by forming a silicone release layer on at least one side of a release liner carrier in the above manner.

Though not critical, the mass of coating of each silicone release layer in the silicone release liner (silicone release layer on one side of the release liner carrier) is, for example, preferably 0.3 g/m² or less (e.g., from 0.02 to 0.3 g/m²), more preferably from 0.05 to 0.2 g/m², and furthermore preferably from 0.05 to 0.15 g/m². The control of the mass of coating to be 0.3 g/m² or less may reduce the amount of silicone compounds (particularly low-molecular-weight silicone compounds) to be attached to the adhesive faces or to be absorbed by the pressure-sensitive adhesive layers and may thereby suppress the evolution of siloxane gas. In contrast, the control of the mass of coating to be 0.02 g/m² or more may provide a sufficient release force. The “mass of coating of the silicone release layer” is also referred to as a “weight per unit area (1 m²) of the silicone release layer.”

[Properties and Other Characteristics of Double-Sided Pressure-Sensitive Adhesive Sheet]

The double-sided pressure-sensitive adhesive sheet according to the present invention, when heated at 120° C. for 10 minutes, evolves a siloxane gas, if any, in an amount (hereinafter also referred to as “siloxane gas emission”) of 1 ng/cm² or less, more preferably 0.8 ng/cm² or less, and furthermore preferably 0.4 ng/cm² or less, as measured according to a measuring method mentioned later. In general, the fact that a double-sided pressure-sensitive adhesive sheet evolves siloxane gases in a less amount means that less amounts of silicone compounds (particularly low-molecular-weight silicone compounds), which cause the siloxane gases, are present, namely, less amounts of silicone compounds are attached to the adhesive faces of the double-sided pressure-sensitive adhesive sheet and are absorbed by the pressure-sensitive adhesive layers. This suppresses pollution of adherends and electronic components with silicone compounds, in products using the double-sided pressure-sensitive adhesive sheet. For this reason, the control of the siloxane gas emission particularly to be 1 ng/cm² or less may effectively suppress the pollution typically of electronic components caused by siloxane gases and silicone compounds and may prevent problems such as malfunctions of products such as electronic appliances.

The siloxane gas emission may be controlled typically by regulating the composition and mass of coating of the silicone release agent and heating conditions for the formation of the silicone release layer.

The siloxane gas emission of the double-sided pressure-sensitive adhesive sheet according to the present invention may be determined by removing both the silicone release liners from the double-sided pressure-sensitive adhesive sheet to expose adhesive faces; applying a PET film as a backing to one adhesive face of the pressure-sensitive adhesive unit to give a specimen; heating this specimen; and measuring the amount of siloxane gas evolved from the other adhesive face which is not covered by the backing. More specifically, the siloxane gas emission may be measured according to the method described in “(1) Siloxane Gas Amount (siloxane gas emission)” in after-mentioned “Evaluations.” The double-sided pressure-sensitive adhesive sheet preferably shows a siloxane gas emission within the above-specified range when any of the two adhesive faces thereof is subjected to the measurement.

The double-sided pressure-sensitive adhesive sheet has an outgassing (total outgassing: the total amount of evolved outgases) of preferably 1 μg/cm² or less, more preferably 0.8 μg/cm² or less, and furthermore preferably 0.7 μg/cm² or less. The outgassing herein is determined while heating a sample sheet at a temperature of 120° C. for 10 minutes and measuring the total amount of evolved gases according to a measuring method mentioned later. The double-sided pressure-sensitive adhesive sheet, when having an outgassing of 1 μg/cm² or less, may not cause corrosion and malfunction of electronic appliances (e.g., hard disk drives) due to outgas components and is superior in long-term reliability even when the double-sided pressure-sensitive adhesive sheet is used for fixing a FPC in the electronic appliances (e.g., hard disk drives). These outgases are generally derived from silicone release agents in release liners and unreacted monomer components in pressure-sensitive adhesive layers. Thus, outgassing may be reduced in the present invention typically by controlling the siloxane gas emission from the double-sided pressure-sensitive adhesive sheet. Outgassing may also be reduced by regulating the type of polymerization initiator for the acrylic polymer and the molecular weight of the acrylic polymer within the preferred ranges. The outgassing of the double-sided pressure-sensitive adhesive sheet may be determined by removing the two silicone release liners from the double-sided pressure-sensitive adhesive sheet to expose adhesive faces, applying a PET film as a backing to one adhesive face of the pressure-sensitive adhesive unit to give a specimen, heating the specimen, and measuring the amount of outgases evolved from the other adhesive face which is not covered by the backing. More specifically, the outgassing may be measured according to a method described in “(2) Outgassing” in “Evaluations” mentioned later. The double-sided pressure-sensitive adhesive sheet preferably shows an outgassing within the above-specified range when any of the two adhesive faces thereof is subjected to the measurement.

The double-sided pressure-sensitive adhesive sheet has a gap height of preferably 1.5 mm or less, more preferably from 0 to 1 mm, and furthermore preferably from 0 to 0.8 mm. Particularly when used for fixing a flexible printed circuit board (FPC), the control of the gap height to be 1.5 mm or less may allow the double-sided pressure-sensitive adhesive sheet to have excellent repelling resistance even during warming or heating. This may prevent “gap” of the FPC even when the FPC is affixed through the double-sided pressure sensitive adhesive sheet to an adherend and is then heated or warmed. As used herein the term “repelling resistance” refers to such a property as to hardly cause repulsion (resilience) due to bending or another deformation applied typically in a bump portion of the adherend.

The gap height is determined in the following manner: A test specimen is prepared by affixing one adhesive face of the double-sided pressure-sensitive adhesive sheet (10 mm wide and 90 mm long) to one entire side of an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-sided pressure-sensitive adhesive sheet is affixed to an adherend through compression bonding using a roll laminator, where the adherend is a sheet prepared by affixing a polyimide film to a polypropylene sheet 2 mm thick, and the other adhesive face is affixed to the polyimide film of the adherend; the resulting article is left stand at 23° C. for 24 hours, thereafter heated at 70° C. for 2 hours, and the height or distance (mm) of an end of the test specimen lifted or raised from the adherend surface is measured and defined as the “gap height” (mm). More specifically, the gap heights can be measured by the method described in “(5) Gap Height (at 70° C. for 2 hours)” in “Evaluations” mentioned later. The double-sided pressure-sensitive adhesive sheet preferably has a gap height within the above-specified range when any of the adhesive faces is applied to the aluminum sheet during the measurement.

In a preferred embodiment of the double-sided pressure-sensitive adhesive sheet, the release force between the pressure-sensitive adhesive unit and one release liner on one adhesive face of the pressure-sensitive adhesive unit differs from the release force between the pressure-sensitive adhesive unit and the other release liner on the other adhesive face, because this improves the workability such as peeling workability. The release force between the pressure-sensitive adhesive unit and the release liner on a side with a smaller release force (light-release side) (hereinafter referred to as “release force of light-release side”) is preferably from 0.01 to 0.3 newtons per 50 millimeters (N/50 mm), more preferably from 0.05 to 0.3 N/50 mm, and furthermore preferably from 0.1 to 0.3 N/50 mm. On the other hand, the release force between the pressure-sensitive adhesive unit and the release liner on a side with a more release force (heavy-release side) (hereinafter referred to as “release force of heavy-release side”) is preferably from 0.1 to 2 N/50 mm. The difference between the release force of light-release side and that of heavy-release side (difference in release force) is preferably 0.05 N/50 mm or more, and more preferably from 0.1 to 1 N/50 mm. The difference in release force is represented by the formula: [(release force of heavy-release side)-(release force of light-release side)]. As used herein the term “release force” refers to a 180-degree peel strength (180-degree peel adhesion) of the release liner (silicone release liner) with respect to the pressure-sensitive adhesive unit as measured in a 180-degree peel test in accordance with Japanese Industrial Standards (JIS) Z0237 (2000).

The double-sided pressure-sensitive adhesive sheet according to the present invention is a double-sided pressure-sensitive adhesive sheet used for fixing one or more flexible printed circuit boards (FPCs) to an adherend (double-sided pressure-sensitive adhesive sheet for fixing a flexible printed circuit board). Exemplary adherends to be fixed to a FPC through the double-sided pressure-sensitive adhesive sheet include, but are not limited to, cellular phone cabinets, motors, bases, substrates (boards), and covers. Affixation (fixation) of a FPC to the adherend through the double-sided pressure-sensitive adhesive sheet gives, for example, hard disk drives, cellular phones, and motors. Above all, the double-sided pressure-sensitive adhesive sheet is preferably used for the manufacture of hard disk drives which should be protected from pollution with silicone compounds. As has been described above, the double-sided pressure-sensitive adhesive sheet less causes pollution of the adherend with silicone compounds and siloxane gases derived from the double-sided pressure-sensitive adhesive sheet and thereby gives high-quality products (e.g., hard disk drives) with excellent reliability.

Though not limited; the flexible printed circuit board (FPC) may be composed of an electrical insulating (dielectric) layer (hereinafter also referred to as a “base insulating layer”), an electroconductive layer (hereinafter also referred to as a “conductive layer”) arranged as a predetermined circuit pattern on or above the base insulating layer, and, where necessary, a covering electrical insulating layer (hereinafter also referred to as a “cover insulating layer”) arranged on or above the conductive layer. The flexible printed circuit board may have a multilayer structure in which two or more circuit boards are stacked.

The base insulating layer is an electrically insulating layer prepared from an electrically insulating material. The electrically insulating material to form the base insulating layer is not limited and may be suitably chosen from among electrically insulating materials for use in known flexible printed circuit boards. Preferred examples of such electrically insulating materials include plastic materials such as polyimide resins, acrylic resins, poly(ether nitrile) resins, poly(ether sulfone) resins, polyester resins (e.g., poly(ethylene terephthalate)s and poly(ethylene naphthalate)s), poly(vinyl chloride) resins, poly(phenylene sulfide) resins, poly(ether ether ketone) resins, polyamide resins (e.g., so-called “aramid resins”), polyarylate resins, polycarbonate resins, and liquid crystal polymers. Each of different electrically insulating materials may be used alone or in combination. Among them, polyimide resins are more preferred. The base insulating layer may have a single-layer structure or multilayer structure. The surface of the base insulating layer may have been subjected to one or more surface treatments such as corona discharge treatment, plasma treatment, roughening, and hydrolyzing. Though not critical, the thickness of the base insulating layer is preferably from 3 to 100 μm, more preferably from 5 to 50 μm, and furthermore preferably from 10 to 30 μm.

The conductive layer is an electroconductive layer prepared from an electroconductive material. The conductive layer is provided to form a predetermined circuit pattern on or above the base insulating layer. The electroconductive material to form the conductive layer is not especially limited and may be suitably chosen from among electroconductive materials for use in known flexible printed circuit boards. Exemplary electroconductive materials include metallic materials such as copper, nickel, gold, and chromium, as well as alloys (for example, solder) and platinum; and electroconductive plastic materials. Each of different electroconductive materials can be used alone or in combination. Among them, metallic materials are preferred, of which copper is particularly preferred. The conductive layer may have a single-layer structure or multilayer structure. The surface of the conductive layer may have been subjected to one or more surface treatments. Though not critical, the thickness of the conductive layer is preferably from 1 to 50 μm, more preferably from 2 to 30 μm, and furthermore preferably from 3 to 20 μm.

The way to form the conductive layer is not limited and may be chosen from among known formation processes for conductive layers, including known patterning processes such as subtractive process, additive process, and semi-additive process. Typically, when to be arranged directly on the surface of the base insulating layer, the conductive layer may be provided by forming a layer of an electroconductive material as a predetermined circuit pattern on the base insulating layer typically through plating or vapor deposition. Exemplary techniques usable herein include electroless plating, electrolytic plating, vacuum vapor deposition, and sputtering.

The cover insulating layer is a covering electrically insulating layer (protective electrically insulating layer) which is prepared from an electrically insulating material and covers the conductive layer. The cover insulating layer may be provided according to necessity but is not necessarily provided. The electrically insulating material to form the cover insulating layer is not limited and may be chosen from among electrically insulating materials for use in known flexible printed circuit boards, as in the base insulating layer. Specific examples of electrically insulating materials for the formation of the cover insulating layer include the electrically insulating materials listed above as the electrically insulating materials for the formation of the base insulating layer. Among them, plastic materials are preferred, of which polyimide resins are more preferred, as in the base insulating layer. Each of different electrically insulating materials can be used alone or in combination for the formation of the cover insulating layer. The cover insulating layer may have a single-layer structure or multilayer structure. The surface of the cover insulating layer may have been subjected to one or more surface treatments such as corona discharge treatment, plasma treatment, roughening, and hydrolyzing. Though not critical, the thickness of the cover insulating layer is preferably from 3 to 100 μm, more preferably from 5 to 50 μm, and furthermore preferably from 10 to 30 μm.

The way to form the cover insulating layer is not especially limited and may be suitably chosen from among know formation techniques. Exemplary formation techniques include a technique of applying a layer of a liquid or melt containing an electrically insulating material, and drying the applied layer; and a technique of previously forming a film or sheet corresponding to the dimensions of the conductive layer and containing an electrically insulating material, and laying the film or sheet on the conductive layer.

[Method for Manufacturing Double-Sided Pressure-Sensitive Adhesive Sheet]

The double-sided pressure-sensitive adhesive sheet may be manufactured by any method suitably chosen from among known methods for forming pressure-sensitive adhesive sheets. Embodiments of a method for manufacturing the double-sided pressure-sensitive adhesive sheet will be mentioned below.

For example, when an acrylic pressure-sensitive adhesive composition containing an acrylic polymer as an essential component (e.g., a solution of acrylic pressure-sensitive adhesive composition) is used in the method for manufacturing the double-sided pressure-sensitive adhesive sheet, the pressure-sensitive adhesive layers on both sides of a substrate may each be formed by either a direct coating process or transfer process. In the direct coating process, the acrylic pressure-sensitive adhesive composition is applied to a surface of the substrate, and the applied layer is dried and/or cured according to necessity. In the transfer process, the acrylic pressure-sensitive adhesive composition is applied to a silicone release liner, and the applied layer is dried and/or cured according to necessity to form a pressure-sensitive adhesive layer thereon, and the pressure-sensitive adhesive layer is affixed(transferred) to a surface of the substrate.

When an acrylic pressure-sensitive adhesive composition containing, as an essential component, a mixture of monomer components (monomer mixture) for the formation of an acrylic polymer or a partial polymer thereof is used in the manufacturing method, the pressure-sensitive adhesive layers may each be formed by either a direct coating process or transfer process. In the direct coating process, the acrylic pressure-sensitive adhesive composition is directly applied to a surface of the substrate, and the applied layer is cured through the irradiation with an active energy ray. In the transfer process, the acrylic pressure-sensitive adhesive composition is applied to a silicone release liner, the applied layer is cured through the irradiation with an active energy ray to form a pressure-sensitive adhesive layer thereon, and the pressure-sensitive adhesive layer is affixed to a surface of the substrate. Where necessary, the formed pressure-sensitive adhesive layer may be further dried.

The coating (application) of the acrylic pressure-sensitive adhesive composition in the formation of the pressure-sensitive adhesive layers may employ a known coating process and employ a customary coater such as gravure roll coater, reverse roll coater, kiss roll coater, dip roll coater, bar coater, knife coater, or spray coater.

The above processes for forming pressure-sensitive adhesive layers provides pressure-sensitive adhesive layers on both sides of the substrate and thereby gives a pressure-sensitive adhesive unit in the double-sided pressure-sensitive adhesive sheet.

Of the above-mentioned processes, a transfer process is preferably employed for forming at least one of the two pressure-sensitive adhesive layers on both sides of the substrate in the double-sided pressure-sensitive adhesive sheet. In the transfer process, a pressure-sensitive adhesive composition is applied to a silicone release liner to form a pressure-sensitive adhesive layer thereon, and the formed pressure-sensitive adhesive layer is affixed to a surface of the substrate. Specifically, the method for manufacturing a double-sided pressure-sensitive adhesive sheet according to the present invention preferably includes at least the steps of applying a pressure-sensitive adhesive composition to a silicone release liner to form a pressure-sensitive adhesive layer thereon; and affixing the pressure-sensitive adhesive layer to a surface of a substrate.

An exemplary preferred embodiment of the method for manufacturing the double-sided pressure-sensitive adhesive sheet is as follows. Specifically, the double-sided pressure-sensitive adhesive sheet is manufactured by applying a pressure-sensitive adhesive composition to a surface of a silicone release layer of a silicone release liner; drying and/or curing the applied composition according to necessity to form a pressure-sensitive adhesive layer on the silicone release layer; affixing the formed pressure-sensitive adhesive layer to one surface of a substrate; applying a pressure-sensitive adhesive composition to the other surface of the substrate; drying and/or curing the applied composition to form another pressure-sensitive adhesive layer; and providing another silicone release liner on the surface of the second pressure-sensitive adhesive layer. This method can employ a thin substrate and is thereby particularly preferred.

In another exemplary preferred embodiment of the method for manufacturing a double-sided pressure-sensitive adhesive sheet, the double-sided pressure-sensitive adhesive sheet is manufactured by applying a pressure-sensitive adhesive composition to a surface of a silicone release layer of a silicone release liner and drying and/or curing the applied composition according to necessity to form a pressure-sensitive adhesive layer thereon; thus providing two plies of pressure-sensitive adhesive layers; and affixing the two pressure-sensitive adhesive layers to both sides of a substrate, respectively. The affixation operations of the two pressure-sensitive adhesive layers to the both sides of the substrate may be performed simultaneously or sequentially.

The method for manufacturing a double-sided pressure-sensitive adhesive sheet just mentioned above can manufacture the double-sided pressure-sensitive adhesive sheet with high productivity, even when the substrate is thin and susceptible to rupture, and it is difficult to form pressure-sensitive adhesive layers by a direct coating process in which a pressure-sensitive adhesive composition is directly applied to the substrate. In addition, the method can give a double-sided pressure-sensitive adhesive sheet having further improved properties such as bump absorptivity, because the method manufactures the double-sided pressure-sensitive adhesive sheet with good productivity even when a further thin substrate is employed.

### EXAMPLES

The present invention will be illustrated in further detail with reference to several working examples below. It should be noted, however, that the examples are never construed to limit the scope of the present invention.

Release Liner Preparation Example 1

A silicone release agent (solvent silicone release agent) was prepared by blending 100 parts by weight of a thermosetting addition silicone under the trade name “KS-847H” (supplied by Shin-Etsu Chemical Co., Ltd., having a solids concentration of 30 percent by weight) with 1 part by weight of a platinum catalyst under the trade name “PL-50T” (supplied by Shin-Etsu Chemical Co., Ltd.), and further adding toluene thereto to have a solids concentration of 1 percent by weight.

The silicone release agent was applied to one surface of a PET film (trade name “Lumirror S10” supplied by Toray Industries Inc., having a thickness of 50 μm) to form a layer in a mass of coating in terms of solids content of 0.1 g/m², followed by drying in an oven at 130° C. for 1 minute. The dried agent was then aged at 25° C. for 24 hours and thereby yielded a silicone release liner including the PET film and, arranged on one side thereof, a silicone release layer (mass of coating of silicone release layer: 0.1 g/m²) (hereinafter also referred to as Release Liner “a”). Release Liner “a” was used as a release liner of light-release side (first surface side) in double-sided pressure-sensitive adhesive sheets mentioned later.

Release Liner Preparation Example 2

A silicone release liner including a PET film and, on one side thereof, a silicone release layer (mass of coating of silicone release layer: 0.1 g/m²) (hereinafter also referred to as Release Liner “b”) was prepared by the procedure of Release Liner Preparation Example 1, except for preparing a silicone release agent (solvent silicone release agent) by blending 90 parts by weight of a thermosetting addition silicone under the trade name “KS-3703” (supplied by Shin-Etsu Chemical Co., Ltd., having a solids concentration of 30 percent by weight) with 10 parts by weight of a release-controlling agent under the trade name “X-92-183” (supplied by Shin-Etsu Chemical Co., Ltd., having a solids concentration of 30 percent by weight) and 1 part by weight of a platinum catalyst under the trade name “PL-50T” (supplied by Shin-Etsu Chemical Co., Ltd.); and further adding toluene thereto to have a solids concentration of 1 percent by weight. Release Liner “b” was used as a release liner of heavy-release side (second surface side) in the double-sided pressure-sensitive adhesive sheets mentioned later.

Release Liner Preparation Example 3

A silicone release agent (solvent-free silicone release agent) was prepared by blending 100 parts by weight of a thermosetting silicone under the trade name “SP 7265S” (supplied by Dow Corning Toray Co., Ltd.) with 10 parts by weight of a platinum catalyst under the trade name “SP 7243S” (supplied by Dow Corning Toray Co., Ltd.).

The above-prepared silicone release agent was applied to one side of a high-quality laminated paper (trade name “LL-50N”, supplied by LINTEC Corporation) to form a layer in a mass of coating of 1 g/m², followed by drying in an oven at 130° C. for 1 minute. The dried layer was then aged at 25° C. for 24 hours and thereby yielded a silicone release liner including the high-quality laminated paper and, on one side thereof, a silicone release layer (mass of coating of silicone release layer: 1 g/m²) (hereinafter also referred to as Release Liner “c”). Release Liner “c” was used as a release liner of heavy-release side (second surface side) in the double-sided pressure-sensitive adhesive sheets mentioned below.

### Example 1

A solution (solids concentration: 25 percent by weight) of an acrylic polymer (hereinafter referred to as “Acrylic Polymer 1”) having a weight-average molecular weight of 150×10⁴ was prepared by subjecting 93 parts by weight of n-butyl acrylate, 7 parts by weight of acrylic acid, and 0.05 part by weight of 4-hydroxybutyl acrylate to solution polymerization according to a common procedure while using ethyl acetate as a solvent and 0.1 part by weight of azobisisobutyronitrile as an initiator. The solution was combined with 0.2 part by weight (in terms of solids content) of an isocyanate crosslinking agent and 0.01 part by weight of an epoxy crosslinking agent per 100 parts by weight of the acrylic polymer and thereby yielded a pressure-sensitive adhesive composition as a solution (acrylic pressure-sensitive adhesive composition). The isocyanate crosslinking agent was a product supplied by Nippon Polyurethane Industry Co., Ltd. under the trade name “CORONATE L” having a solids concentration of 75 percent by weight. The epoxy crosslinking agent was a product supplied by Mitsubishi Gas Chemical Company, Inc. under the trade name “TETRAD C.”

The pressure-sensitive adhesive composition was applied to the surface of the silicone release layer of Release Liner “b” and dried at 130° C. for 3 minutes to form a pressure-sensitive adhesive layer having a dry thickness (thickness of the pressure-sensitive adhesive layer alone) of 23 μm, and the surface of the pressure-sensitive adhesive layer was affixed to one surface of a PET film substrate (trade name “Lumirror #5AF53”, supplied by Toray Industries Inc., having a thickness of 5 μm). Next, the pressure-sensitive adhesive composition was applied to the other surface of the PET film substrate, dried at 130° C. for 3 minutes to form a pressure-sensitive adhesive layer having a dry thickness of 23 μm, and Release Liner “a” was affixed to the surface of the formed pressure-sensitive adhesive layer and thereby yielded a double-sided pressure-sensitive adhesive sheet.

### Comparative Example 1

A solution (solids concentration: 20 percent by weight) of an acrylic polymer (hereinafter also referred to as “Acrylic Polymer 2”) having a weight-average molecular weight of 100×10⁴ was prepared by subjecting 90 parts by weight of 2-ethylhexyl acrylate and 10 parts by weight of acrylic acid to solution polymerization according to a common procedure using ethyl acetate as a solvent and 0.5 part by weight of benzoyl peroxide as an initiator. The solution was combined with 2 parts by weight (in terms of solids content) of an isocyanate crosslinking agent (supplied by Nippon Polyurethane Industry Co., Ltd. under the trade name “CORONATE L”, having a solids concentration of 75 percent by weight) per 100 parts by weight of the acrylic polymer, to give a pressure-sensitive adhesive composition as a solution (acrylic pressure-sensitive adhesive composition).

The prepared pressure-sensitive adhesive composition was applied to a surface of the silicone release layer of Release Liner “c” and dried at 130° C. for 3 minutes to form a pressure-sensitive adhesive layer having a dry thickness (thickness of the pressure-sensitive adhesive layer alone) of 50 μm. Next, Release Liner “a” was affixed to the surface of the pressure-sensitive adhesive layer and thereby yielded a double-sided pressure-sensitive adhesive sheet (substrate-less double-sided pressure-sensitive adhesive sheet).

### Comparative Example 2

A double-sided pressure-sensitive adhesive sheet (substrate-less double-sided pressure-sensitive adhesive sheet) was manufactured by the procedure of Comparative Example 1, except for using Release Liner “b” instead of Release Liner “c.”

Evaluations

The double-sided pressure-sensitive adhesive sheets prepared according to the example and comparative examples were subjected to measurements and evaluations according to methods described below. The gel fractions of pressure-sensitive adhesive layers were measured by the method described above. The results of the measurements and evaluations are shown in Table 1.

(1) Siloxane Gas Emission

The release liner of light-release side was removed from each of the double-sided pressure-sensitive adhesive sheets obtained in the example and comparative examples to expose an adhesive face, and a PET film (supplied by Toray Industries Inc. under the trade name “Lumirror S-10”, having a thickness of 25 μm) was applied to the adhesive face. The double-sided pressure-sensitive adhesive sheet bearing the PET film on one side thereof was then cut to a size of 1 cm wide and 7 cm long, from which the release liner of heavy-release side was removed, and thereby yielded a series of test specimens.

Each of the test specimens was heated at 120° C. for 10 minutes in a purge and trap headspace sampler, evolved gases were trapped, and the trapped components were analyzed with a gas chromatograph/mass spectrometer. The amount of siloxane gases (detected D3 to D6 (cyclic siloxanes)) in the components was determined by calculation using a calibration curve prepared with D3 to D6 standards. This amount was converted into a value per unit area of the pressure-sensitive adhesive layer without the PET film and defined as a siloxane gas emission in units of nanograms per square centimeter (ng/cm²).

The calibration curve with the D3 to D6 standards was prepared by injecting a solution of the D3 to D6 standards (concentration: 1 ng/μg or 10 ng/μg) into a heating chamber with a microsyringe (injection volume: 1 μl), heating the solution, trapping an evolved gas, and analyzing and measuring the gas with a gas chromatograph/mass spectrometer.

(2) Outgassing

The release liner of light-release side was removed from each of the double-sided pressure-sensitive adhesive sheets obtained in the example and comparative examples to expose an adhesive face, and a PET film (supplied by Toray Industries Inc, under the trade name “Lumirror S-10”, having a thickness of 25 μm) was applied to the adhesive face. The double-sided pressure-sensitive adhesive sheet bearing the PET film on one side thereof was then cut to a size of 1 cm wide and 7 cm long, from which the release liner of heavy-release side was removed, and thereby yielded a series of test specimens.

Each of the test specimens was heated at 120° C. for 10 minutes in a purge and trap headspace sampler, evolved gases were trapped, and the trapped components were analyzed with a gas chromatograph/mass spectrometer. The amount of evolved gases was determined as a value in terms of n-decane standard, was converted into a value per unit area of the pressure-sensitive adhesive layer without the PET film, and was defined as an outgassing (outgas amount upon heating at 120° C. for 10 minutes) in units of micrograms per square centimeter (μg/cm²).

(3) Adhesive Strength

Strip specimens each 20 mm wide and 150 mm long were prepared from the double-sided pressure-sensitive adhesive sheets obtained in the example and comparative examples.

The specimens were subjected to 180-degree peel tests using a tensile tester in accordance with the method prescribed in JIS 20237 (2000) to measure a 180-degree peel strength (N/20 mm) upon peeling from a test plate (SUS 304-BA stainless steel plate), and the measured 180-degree peel strength was defined as the “adhesive strength.”

The affixation of the specimen to the test plate was conducted in the following manner: the release liner of light-release side was removed from each of the prepared double-sided pressure-sensitive adhesive sheets to expose a surface; a PET film 25 μm thick was affixed (lined) to the exposed surface; the other release liner of heavy-release side was then removed to expose another surface; this exposed surface was laid on the test plate; and a 2-kg rubber roller (about 45 mm wide) was placed thereon and moved as one reciprocating motion.

The measurement was conducted under conditions at a peel angle of 180 degrees and a tensile speed of 300 mm per minute at an ambient temperature of 23° C. and relative humidity of 50%, and an adhesive strength was calculated. The test was conducted a total of three times per sample (n=3), and the average of the three measurements was defined as the adhesive strength of the sample.

(4) Release Force of Release Liners

Strip sheet pieces 50 mm wide and 150 mm long were cut from the double-sided pressure-sensitive adhesive sheets prepared according to the example and comparative examples and used as test specimens for the measurement of a release force of light-release side. For the measurement of a release force of heavy-release side, the release liner of light-release side was removed to expose a surface, and a PET film 25 μm thick was affixed (lined) to the exposed surface to give test specimens.

Each of the test specimens was subjected to a 180-degree peel test using a tensile tester according to the method prescribed in JIS Z0237 (2000) to measure a 180-degree peel strength (N/50 mm) of each release liner, and the measured 180-degree peel strength was defined as a “release force of release liner.”

The measurement was conducted under conditions at a peel angle of 180 degrees and a tensile speed of 300 mm per minute in an ambient temperature of 23° C. and relative humidity of 50%, and an adhesive strength was calculated. The test was conducted a total of three times per sample (n=3), and the average of the three measurements was defined as the release force.

Tests were conducted on both the release liners of heavy-release side and of light-release side. In the measurement of a release force of the release liner of heavy-release side, the adhesive face from which the release liner of light-release side had been removed was lined (backed) with a PET film, as described above.

(5) Gap Height (at 70° C. for 2 Hours)

Test specimens were prepared from the double-sided pressure-sensitive adhesive sheets (size: 10 mm wide and 90 mm long) prepared according to the example and comparative examples by removing the release liner of light-release side to expose an adhesive face, and affixing the exposed adhesive face (light-release side) to an aluminum sheet 0.5 mm thick, 10 mm wide, and 90 mm long. The test specimens were bent in the longitudinal direction into an arc along a round rod having a diameter of 50 mm so that the pressure-sensitive adhesive sheet faced outward; the release liner of heavy-release side was removed from each test specimen to expose the adhesive face of heavy-release side; and this exposed adhesive face was affixed to an adherend through compression bonding under a linear pressure of 0.3 MPa using a roll laminator. The adherend was a sheet prepared by affixing a polyimide film “Kapton 100H” to a polypropylene (PP) sheet 2 mm thick through a pressure-sensitive adhesive tape, and the pressure-sensitive adhesive layer was affixed to the polyimide film of the adherend. The article after compression bonding was left stand at an ambient temperature of 23° C. for 24 hours, thereafter heated at 70° C. for 2 hours, and the heights (mm) of both ends of the test specimen split and raised from the adherend surface were measured and averaged as a gap height (mm).

(6) Workability (Processability)

Test specimens for processability evaluation were prepared by half-cutting the double-sided pressure-sensitive adhesive sheets prepared according to the example and comparative examples from the release liner of heavy-release side using a pressing machine, whereby only the release liner of heavy-release side and the pressure-sensitive adhesive unit were notched. The test specimens for processability evaluation were left at an ambient temperature of 60° C. and relative humidity of 90% for one week, and whether autohesion of the cut surfaces occurred or not was observed, and the workability (processability) was evaluated according to the criteria mentioned below.

Criteria for Processability

Good: No autohesion was observed at the cut surfaces.

Poor: Autohesion was observed at the cut surfaces.

(7) Bump Absorbability

The release liner of light-release side was removed from each of the double-sided pressure-sensitive adhesive sheets (size: 40 mm wide and 40 mm long) prepared according to the example and comparative examples to expose an adhesive face, and the exposed adhesive face was applied to a surface of a base film layer of the after-mentioned FPC through compression bonding at a temperature of 60° C. under a pressing force of 0.5 MPa for 10 seconds. After compression bonding, the resulting article was observed from the double-sided pressure-sensitive adhesive sheet side with a microscope of 50 magnifications. A sample showing “adhesion failure (gap)” in a small quantity between the double-sided pressure-sensitive adhesive sheet and the base film layer typically in portions with bumps was evaluated as having good bump absorbability; and one showing “adhesion failure” in a large quantity was evaluated as having poor bump absorbability.

[FPC (Adherend)]

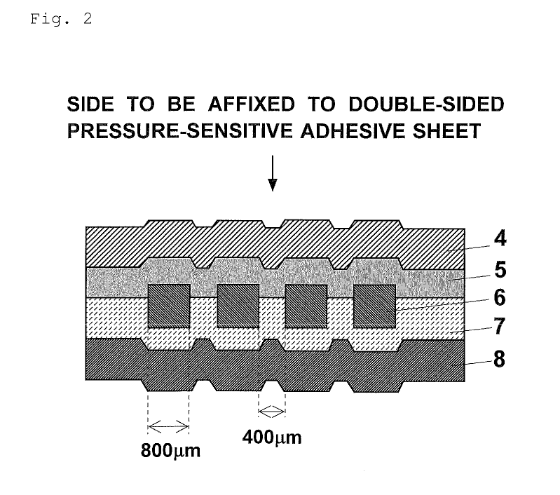

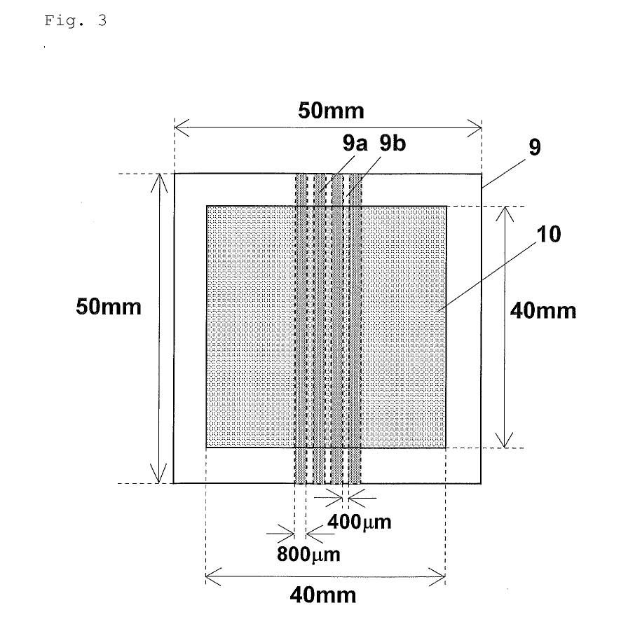

FIG. 2 is an explanatory drawing (schematic cross-sectional view) of a multilayer structure of the FPC used as the adherend above. FIG. 3 is an explanatory drawing (plan view when viewed from the base film layer side) illustrating how and where the double-sided pressure-sensitive adhesive sheet (test sample) was affixed to the FPC.

The FPC structurally includes a base insulating layer; a copper foil layer (conductor layer) 6 present on the base insulating layer; and a covering insulating layer present on the copper foil layer 6. The base insulating layer has a multilayer structure including a polyimide base film layer 4 and an epoxy adhesive layer 5. The covering insulating layer has a multilayer structure including a polyimide cover-lay film layer 8 and an epoxy adhesive layer (cover-lay adhesive layer) 7. The base film layer 4 has a thickness of 0.025 mm, the adhesive layer 5 has a thickness of 0.015 mm, the copper foil layer 6 has a thickness of 0.035 mm, the cover-lay adhesive layer 7 has a thickness of 0.025 mm, and the cover-lay film layer 8 has a thickness of 0.025 mm.

The copper foil layer is formed so as to have four linear circuit traces each having a width of the copper foil (line width) of 800 μm and a width of a space (space) between adjacent copper foils of 400 μm. The surface of the base film layer of the FPC has bumps (steps) caused by the copper foil lines, and spaces between the copper foil lines in the copper foil layer.

The double-sided pressure-sensitive adhesive sheet (test sample) 10 was affixed to the surface of the base film layer of the FPC (adherend) 9 as illustrated in FIG. 3. In FIG. 3, the reference signs “9a” stands for a portion where the copper foil is present, and “9b” stands for a portion where the copper foil is absent.

TABLE 1

| | | | Comparative | Comparative |
|---|---|---|---|---|
| | | Example 1 | Example 1 | Example 2 |
| Substrate (thickness) | | PET film (5 μm) | substrate-less | substrate-less |
| Pressure-sensitive | Acrylic polymer | Acrylic Polymer 1 | Acrylic Polymer 2 | Acrylic Polymer 2 |
| adhesive layers | Amount of epoxy crosslinking | 0.01 | 0 | 0 |
| | agent (part by weight) | | | |
| | Amount of isocyanate | 0.2 | 2 | 2 |
| | crosslinking agent (part by weight) | | | |
| | Thickness of pressure-sensitive | 23 | — | — |
| | adhesive layer (one layer) (μm) | | | |
| Thickness of pressure-sensitive adhesive unit (μm) | | 51 | 50 | 50 |
| Release liner | | Silicone | Silicone | Silicone |
| Mass of coating of silicone release | | 0.1 | 1 | 0.1 |
| layer in release liner (g/m²) | | | | |
| Siloxane gas emission (ng/cm²) | | <0.4 | 5.4 | <0.4 |
| Outgassing (μg/cm²) | | 0.6 | 15 | 1 |
| Workability | | Good | Poor | Poor |
| Gap height (mm) | | 0.5 | 1.3 | 1.3 |
| Bump absorbability | | Good | Good | Good |
| Gel fraction (%) | | 40 | 70 | 70 |
| Adhesive strength (N/20 mm) | | 10 | 8.6 | 8.6 |
| Release force of | Light-release side (N/50 mm) | 0.1 | 0.1 | 0.1 |
| release liner | Heavy-release side (N/50 mm) | 0.3 | 0.3 | 0.3 |

The data shown in Table 1 demonstrate that the double-sided pressure-sensitive adhesive sheet according to the present invention (Example 1) evolved siloxane gases in a small amount (showed a low siloxane gas emission) and excelled in workability (processability); and, in contrast to this, the double-sided pressure-sensitive adhesive sheet according to Comparative Example 1 evolved siloxane gases in a large amount (showed a high siloxane gas emission) to cause more pollution; and the double-sided pressure-sensitive adhesive sheets according to Comparative Examples 1 and 2, having no substrate, had poor workability.

### REFERENCE SIGNS LIST

1 double-sided pressure-sensitive adhesive sheet for fixing a flexible printed circuit board
2 pressure-sensitive adhesive unit
21 substrate
22 pressure-sensitive adhesive layer
3 release liner (silicone release liner)
4 base film layer (polyimide film)
5 adhesive layer (epoxy adhesive)
6 copper foil layer
7 cover-lay adhesive layer (epoxy adhesive)
8 cover-lay film layer (polyimide film)
9 FPC (adherend)
9a portion where copper foil is present
9b portion where copper foil is absent
10 double-sided pressure-sensitive adhesive sheet (test sample)

While the above description is of the preferred embodiments of the present invention, it should be appreciated that the invention may be modified, altered, or varied without deviating from the scope and fair meaning of the following claims.

1. A double-sided pressure-sensitive adhesive sheet for fixing a flexible printed circuit board, comprising at least:
a pressure-sensitive adhesive unit including
a substrate,
a first pressure-sensitive adhesive layer present on or above one side of the substrate, and
a second pressure-sensitive adhesive layer present on or above another side of the substrate; and
a first silicone release liner present on or above one surface of the pressure-sensitive adhesive unit, and
a second silicone release liner present on or above another surface of the pressure-sensitive adhesive unit,
wherein each of the first and second pressure-sensitive adhesive layers each include an acrylic polymer based on, as an essential monomer component, at least one alkyl (meth)acrylate whose alkyl moiety being a linear or branched-chain alkyl group having 1 to 14 carbon atoms,
wherein the pressure-sensitive adhesive unit has a thickness of 60 μm or less, and
wherein the adhesive sheet evolves a siloxane gas or gases, if any, in a total amount of 1 ng/cm² or less when heated at 120° C. for 10 minutes.

2. The double-sided pressure-sensitive adhesive sheet for fixing a flexible printed circuit board, according to claim 1, wherein the substrate is a plastic film substrate having a thickness of 10 μm or less, and each of the first and second pressure-sensitive adhesive layers has a thickness of 20 μm or more.

3. The double-sided pressure-sensitive adhesive sheet for fixing a flexible printed circuit board, according to claim 1, wherein the first and second silicone release liners are release liners each including at least a silicone release layer, and wherein the silicone release layer is provided in a mass of coating of 0.3 g/m² or less.

4. The double-sided pressure-sensitive adhesive sheet for fixing a flexible printed circuit board, according to claim 1, wherein the adhesive sheet outgases, if any, in a total amount of 1 μg/cm² or less when heated at 120° C. for 10 minutes.

5. The double-sided pressure-sensitive adhesive sheet for fixing a flexible printed circuit board, according to claim 1, wherein the adhesive sheet has a gap height as defined below of 1.5 mm or less;
Gap height: A test specimen is prepared by affixing one adhesive face of the double-sided pressure-sensitive adhesive sheet to an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-sided pressure-sensitive adhesive sheet is affixed to an adherend through compression bonding using a roll laminator, where the adherend is a sheet prepared by affixing a polyimide film to a polypropylene sheet 2 mm thick, and the other adhesive face is affixed to the polyimide film of the adherend; the resulting article is left stand at 23° C. for 24 hours, thereafter heated at 70° C. for 2 hours, and the height or distance (mm) of an end of the test specimen lifted or raised from the adherend surface is measured and defined as the “gap height” (mm).

6. The double-sided pressure-sensitive adhesive sheet for fixing a flexible printed circuit board, according to claim 1, wherein each of the first and second pressure-sensitive adhesive layers has a gel fraction of 10% to 60%.

7. A method for manufacturing the double-sided pressure-sensitive adhesive sheet for fixing a flexible printed circuit board as claimed in claim 1, the method comprising at least the steps of:
applying a pressure-sensitive adhesive composition to a silicone release liner to form a pressure-sensitive adhesive layer thereon; and
affixing the pressure-sensitive adhesive layer to a surface of a substrate.
